(19) United States
(12) Patent Application Publication
(10) Pub. No.: US 2012/0082831 A1
(43) Pub. Date: Apr. 5, 2012

(54) Nano-Porous Coatings and Making Methods

(75) Inventors: Qingwu Wang, Chelmsford, MA (US); Sangyup Song, Winchester, MA (US); Vincent DiFilippo, Chelmsford, MA (US); Thomas Curl, Kensington, NH (US)

(73) Assignee: AGILTRON, INC., Woburn, MA (US)

(21) Appl. No.: 13/252,669

(22) Filed: Oct. 4, 2011

Related U.S. Application Data
(60) Provisional application No. 61/344,774, filed on Oct. 4, 2010.

(51) Int. Cl. B05D 5/10; B32B 7/02; B05B 7/00; B32B 27/30

(52) U.S. Cl. 428/213; 427/164; 428/522; 428/451; 118/300; 118/612

(57) ABSTRACT

Methods for depositing multiple layers of nanoporous coatings and systems that implement those methods.

### CROSS REFERENCE TO RELATED APPLICATIONS

This application claims priority of U.S. Provisional Patent Application 61/344,774, Nano-Porous Coatings and Making Methods, filed on Oct. 4, 2010, which is incorporated by reference herein in its entirety for all purposes.

### STATEMENT REGARDING FEDERALLY SPONSORED RESEARCH OR DEVELOPMENT

This invention was made partially with U.S. Government support from the N.A.S.A. under contract number NNM08AA03C. The U.S. Government has certain rights in the invention.

### BACKGROUND

Antireflection coatings are important for all lens based imaging systems but some substrates, wavelengths and environments present greater challenges than others. The simplest design for an optical antireflection coating for a given substrate and a narrow band of wavelengths centered on λ calls for a single thin film whose refractive index n=√(substrate index) with thickness d such that nd=λ/4. When the substrate index is relatively low however, such as for polymethylmethacrylate (PMMA) with index=1.49, it is difficult to identify lower index materials with a target index n=√1.49=1.22, especially if such materials must also be robust and stable in a space environment. The coating material itself must be transparent at the wavelengths of use, which relatively easy to achieve in the near-IR or visible but challenging in the UV spectrum. Finally it must lend itself to a well controlled deposition process capable of very uniform, conformal coatings over large areas. Very few stable materials have such low refractive indices. One approach is to incorporate air into the film (porosity) but this must be done in such a way as to achieve a stable, solid and very smooth film on a nm scale.

This problem confronts space applications that require the use of large plastic Fresnel lenses (2.5 m) for orbiting cosmic ray telescopes which gather light in the 300-400 nm UV band from Cerenkov radiation in the atmosphere. Previous attempts at coating PMMA with AR films resulted in poor adhesion. Commercial processes for plastic optics, such as the use of Teflon coatings for ophthalmic lenses, are not ideal for PMMA since the Teflon index, n=1.31, is too high to provide a single layer solution (the best possible AR coating would have reflectance not less than 0.5%). In addition to the optical efficiency, NASA desires that the coating on large PMMA optics should not require vacuum deposition, is sufficiently conformal to provide uniform coverage of angled wedges comprising the Fresnel structure, has excellent adhesion and environmental stability in space, is low in film stress so as not to distort the optic, and is capable of multi-layer designs. Finally, low scattering is important—which for a film thickness of only 61 nm for a quarterwave film means smooth and defect free surfaces on the scale of 1-2 nm.

There is a need to provide antireflection coatings for some substrates, wavelengths and environments.

There is also a need for methods for depositing multiple layers of nanoporous coatings for systems that implement those methods.

### SUMMARY

Methods for depositing multiple layers of nanoporous coatings and systems that implement those methods are disclosed hereinbelow.

In one embodiment of the methods of these teachings, a method for depositing successive layers in order to produce nanoporous multilayer coatings on a substrate includes depositing on the substrate a polyelectrolyte solution and a nanoparticle solution, repeating the deposition for each successive layer, rinsing the deposited layers, and drying the rinsed deposited layers.

In one instance the method also includes preparing the substrate by dissolving a predetermined block copolymer in a predetermined solvent; the dissolving resulting in a block copolymer solution, immersing the thermoplastic substrate in the block copolymer solution for a predetermined soaking time, the predetermined soaking time being selected such that a monolayer of block copolymer is formed on a surface of the thermoplastic substrate, annealing the thermoplastic surface with the block copolymer monolayer at a predetermined annealing temperature for a predetermined annealing time, the predetermined annealing temperature and annealing time being selected such that block copolymer moeties are integrated into the surface and negatively charged moieties are located on the surface.

In one embodiment, the system of these teachings apparatus for producing nanoporous multilayer coatings on a substrate includes at least one atomizing mist delivery component receiving a liquid and a gas, the liquid comprising a polyelectrolyte solution and/or a nanoparticle solution when used in a coating operation and comprising a rinsing solution when used in a cleaning operation. The atomizing mist delivery component delivers a coating mist when used in a coating operation, a rinsing solution when used in a cleaning operation and a pressurized gas when used in a drying operation. The embodiment also includes at least one thermoplastic substrate disposed to receive fluid from the one or more atomizing mist delivery components.

In one instance, the thermoplastic substrate has at least one monolayer of block copolymer formed on a surface of the thermoplastic substrate, block copolymer moeties integrated into the surface and negatively charged moieties located on the surface.

In one instance, an anti-reflection coating is obtained by practicing the above described embodiment of the method of these teachings.

Other embodiments of the method and of the system of these teachings are also disclosed.

For a better understanding of the present teachings, together with other and further objects thereof, reference is made to the accompanying drawings and detailed description and its scope will be pointed out in the appended claims.

### BRIEF DESCRIPTION OF THE DRAWINGS

FIG. 1 is a graphical representation of one embodiment of the method of these teachings for preparing the substrate and the resulting substrate;

FIG. 2 is another graphical representation of another embodiment of the method of these teachings for preparing the substrate and the resulting substrate;

FIGS. 3a-3d are graphical diagrammatic representations of structure of components of the coating of these teachings;

FIG. 4 is a graphical schematic representation of one embodiment of the system of these teachings;

FIG. 5 is a graphical schematic representation of one embodiment of a component in one embodiment of the system of these teachings;

FIG. 6 is a graphical schematic representation of another embodiment of the system of these teachings; and

FIGS. 7-10 are graphical representations of results from exemplary embodiments of the system of these teachings.

### DETAILED DESCRIPTION

The following detailed description is of the best currently contemplated modes of carrying out these teachings. The description is not to be taken in a limiting sense, but is made merely for the purpose of illustrating the general principles of these teachings, since the scope of these teachings is best defined by the appended claims.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range. However, any ranges not cited in the claims are only intended for illustration and not for limiting the range covered by our invention. Numerical values are cited for exemplary reasons and to identify embodiments and are not intended to limit the general concept of these teachings.

Methods for depositing multiple layers of nanoporous coatings and systems that implement those methods are disclosed hereinbelow.

As described in JERI' ANN HILLER, JONAS D. MENDELSOHN AND MICHAEL F. RUBNER “Reversibly erasable nanoporous anti-reflection coatings from polyelectrolyte multilayers” Nature Materials, VOL 1, SEPTEMBER 2002, 59-63, and in US Patent Application Publication No. 20030215626, Nanoporous Coatings, both of which are Incorporated by reference herein in their entirety and for all purposes, nanoporous thin film coatings comprised of nanoparticles of glass can be engineered to be used as UV AR coatings. These coatings are created by using a layer-by-layer process involving the alternate adsorption of negatively charged nanoparticles and a positively charged polymer. The assembly conditions can be optimized to produce a thin film coating that is loaded with a high density of nanopores. Since the nanopores lower the refractive index of the coating, it functions as a high performance anti-reflection coating; when applied to glass, the transmission of light increases from about 92% to as high as 99.8%. However, the nano structured coatings had only been previously applied using lab-based layer-by-layer self-assembly methods, which have low yield and limited capability for large areas, and their AR capability had only been demonstrated in the visible wavelength range.

Whether by the method disclosed in US Patent Application Publication No. 20030215626 or by the method of these teachings, the coating process can be substantially optimized through tuning the size of nanoparticles, type of polyelectrolyte, pH and concentration of the polyelectrolyte and nano-particle solutions.

One example of a substantially optimized coding, not a limitation of these teachings, is provided in Table 1 below.

TABLE 1
Materials used in the optimized nanoporous coatings process

| | |
|---|---|
| Nano-Particle | SiO₂ |
| Particle Size | 7 nm |
| Particle Concentration | 0.03 wt % |
| pH of Nano-Particle Solution | 9.0 |
| Polyelectrolyte | poly(allylamine hydrochloride) (PAH) |
| | sulfonated polystyrene (SPS) |
| Polyelectrolyte Concentration | 0.01M |
| pH of Polyelectrolyte Solution | 7.5 |
| Adhesion Layer | 4 bilayers of (PAH/SPS) |

In one embodiment, the method of these teachings for preparing a thermoplastic substrate for layer by layer depositions, the substrate being prepared in order to improve adhesion of the deposited layers to the substrate, includes preparing the substrate by: dissolving a predetermined block copolymer in a predetermined solvent; the dissolving resulting in a block copolymer solution, immersing the thermoplastic substrate in the block copolymer solution for a predetermined soaking time, the predetermined soaking time being selected such that a monolayer of block copolymer is formed on a surface of the thermoplastic substrate, annealing the thermoplastic surface with the block copolymer monolayer at a predetermined annealing temperature for a predetermined annealing time, the predetermined annealing temperature and annealing time being selected such that block copolymer moeties are integrated into the surface and negatively charged moieties are located on the surface.

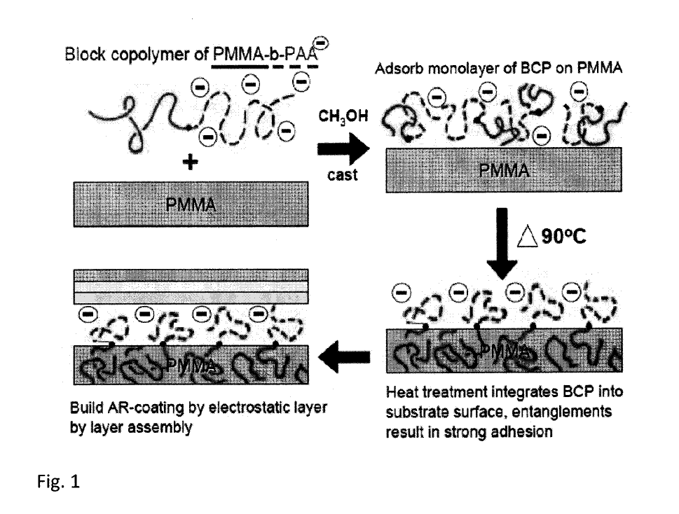

One exemplary embodiment, not a limitation of these teachings, of the surface modification process is shown in FIG. 1. Commercially available poly(methylmethacrylate(9500)-b-acrylic acid (3500) (PMMA-b-PAA) block copolymer was dissolved in a mixed solvent of 50% methanol and 50% water. PMMA slides were soaked in the BCP solution for 12 hrs to get a monolayer BCP on PMMA surface. Then the PMMA slides were washed with de-ionized water (DI) and heat annealed in DI at 90° C. for 2 hrs. The heat annealing process integrates the PMMA moieties of BCP into PMMA surface, and leave the negatively charged PAA moieties on the PMMA substrate surface.

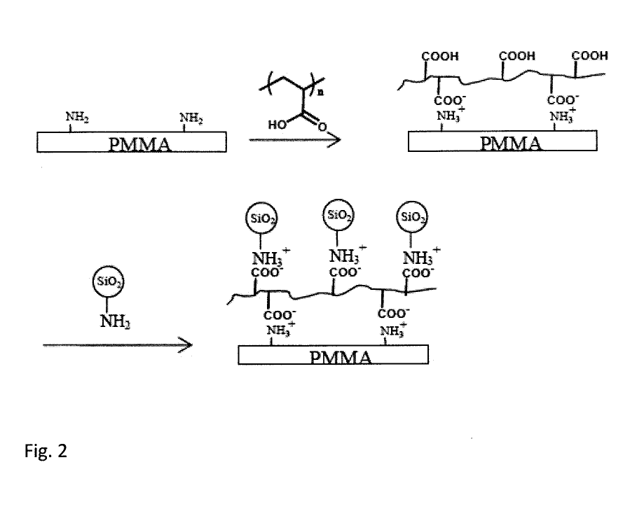

In another instance, an adhesion layer is inserted between the coating and substrate to improve robustness. The surface modification of substrate is intended to introduce amine groups on the surface. These amine groups will chemically react with the coating materials such as PAA, leading to chemical bonds formation between the substrate and coating layer. The interaction of the interface is shown in FIG. 2.

In one embodiment of the methods of these teachings, a method for depositing successive layers in order to produce nanoporous multilayer coatings on a substrate includes depositing on the substrate a polyelectrolyte solution and a nanoparticle solution, repeating the deposition for each successive layer, rinsing the deposited layers, and drying the rinsed deposited layers.

In one instance the method also includes preparing the substrate by dissolving a predetermined block copolymer in a predetermined solvent; the dissolving resulting in a block copolymer solution, immersing the thermoplastic substrate in the block copolymer solution for a predetermined soaking time, the predetermined soaking time being selected such that a monolayer of block copolymer is formed on a surface of the thermoplastic substrate, annealing the thermoplastic surface with the block copolymer monolayer at a predetermined annealing temperature for a predetermined annealing time, the predetermined annealing temperature and annealing time being selected such that block copolymer moeties are integrated into the surface and negatively charged moieties are located on the surface.

The rinsing step substantially cleans the deposited layers and may be performed after each deposition. After the rinsing step, there may be rinsing liquid residues left on the substrate. These residues can dilute concentrations of nanoparticle or polymer solutions to be applied subsequently, or change the solution chemistry. These changes could change the absorption of nanoparticles or polymers. In one embodiment, the drying step is realized by blowing the surface using a high pressure carry gas. If one pass of blowing does not dry the surface completely, additional passes of blowing will be needed. The dying step removes some or all of the residual rinsing liquid, producing a more reproducible and reliable coating.

In one instance, depositing the polyelectrolyte solution and the nanoparticle solution includes alternate deposition of negatively charged nanoparticles and positively charged polyelectrolyte.

In one instance, the deposition is substantially optimized by selecting the size of nanoparticles (the selected size being referred to as a predetermined size), selecting pH and concentration of the nanoparticle solution, selecting a polyelectrolyte and selecting pH and concentration of the polyelectrolyte solution, where the optimization steps can be taken in conjunction or separately or in groups.

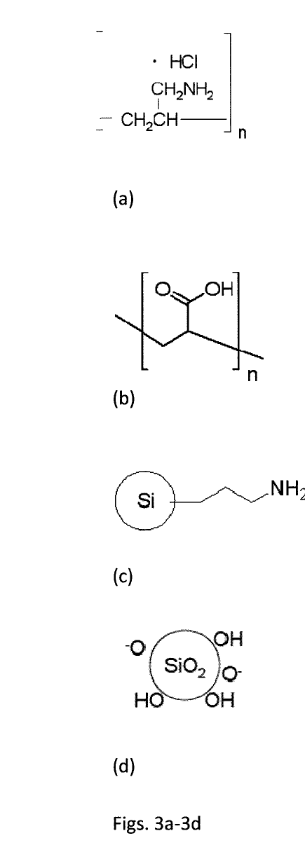

A variety of selections of nanoparticles, sizes and polyelectrolytes are within the scope of these teachings. For example, the selections provided in Table I are within the scope of these teachings. Similarly, charged (+SiO₂) and negatively charged (−SiO₂) nano-particles, and positively and negatively charged poly-electrolytes (PAH, and poly (acrylic acid) (PAA)), whose molecular structures are shown in FIG. 3, are also within the scope of these teachings.

In one instance, the thermoplastic substrate is Poly(methyl methacrylate) (PMMA). In another instance, the block copolymer used in preparing the substrate (also referred to as the predetermined block copolymer) is poly(methylmethacrylate(-b-acrylic acid (PMMA-b-PAA).

In one embodiment, the system of these teachings apparatus for producing nanoporous multilayer coatings on a substrate includes at least one atomizing mist delivery component receiving a liquid and a gas, the liquid comprising a polyelectrolyte solution and/or a nanoparticle solution when used in a coating operation and comprising a rinsing solution when used in a cleaning operation. The atomizing mist delivery component delivers a coating mist when used in a coating operation, a rinsing solution when used in a cleaning operation and a pressurized gas when used in a drying operation. The embodiment also includes at least one thermoplastic substrate disposed to receive fluid from the one or more atomizing mist delivery components. The at least one atomizing mist delivery component and the thermoplastic substrate are displaceable with respect to each other.

In one instance, the thermoplastic substrate has at least one monolayer of block copolymer formed on a surface of the thermoplastic substrate, block copolymer moeties integrated into the surface and negatively charged moieties located on the surface.

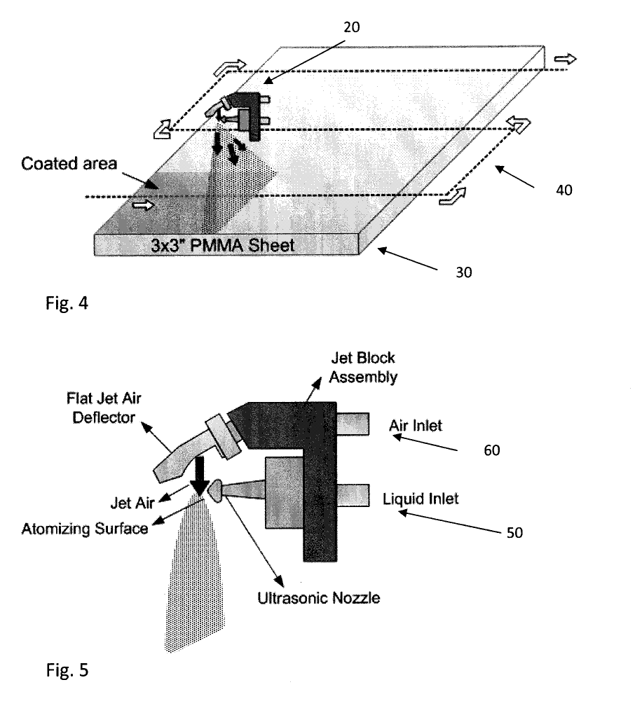

One exemplary embodiment, not a limitation of these teachings, of the system of these teachings is shown in FIG. 4. Although the system shown in FIG. 4 uses an impact ultrasonic nozzle, such as that shown in FIG. 5, as the atomizing mist delivery component, it should be noted that other embodiments of the atomizing mist delivery component are also within the scope of these teachings. For example, components such as, but not limited to, an air assisted atomizing nozzle or a piezoelectric-assisted atomizing nozzle are also within the scope of these teachings.

Referring to FIG. 4, in the embodiment shown therein, an impact ultrasonic nozzle (the atomizing mist delivery component) 20 sprays a coating mist onto the substrate 30. In one instance, the substrate 30 has been prepared according to the method disclosed hereinabove. The impact ultrasonic nozzle 20 can be displaced with respect to the substrate 30. In the embodiment shown in FIG. 4, conventional transport and control components are used to transport the impact ultrasonic nozzle 20 along the path 40, also controlling the deposition so that it only occurs over the substrate 30.

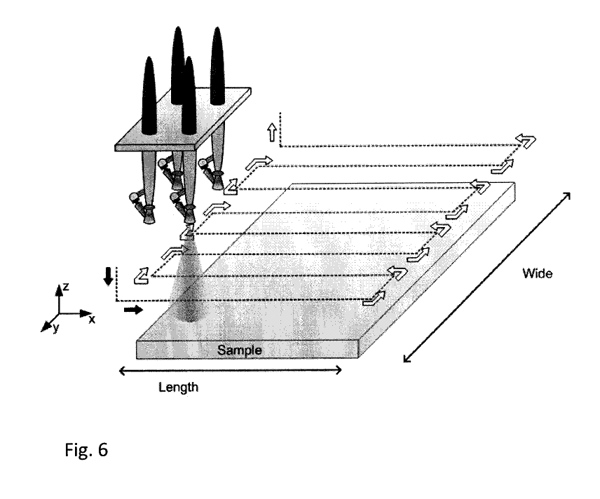

Referring to FIG. 5, in the embodiment shown therein, the impact ultrasonic nozzle (the atomizing mist delivery component) has inlets 50, 60 to receive a liquid and a gas and delivers a mist. Another exemplary embodiment of the system of these teachings is shown in FIG. 6. In the embodiment shown in FIG. 6, four nozzles, equipped for layer-by-layer (LbL) coating, are used to spray oppositely charged polymer and nano-particles, DI water (for cleaning), and high-pressure air (for drying). The X-Y movements are controlled by an automated mechanics. Coating pressure, coating pathway, coating speed, and coating distance can be controlled from easy programming.

The method and systems of these teachings can be used to produce anti-reflective coatings. Using thinner coatings (about 60-70 nm), the transmittance maximum of PAH/SiO₂ based nanoporous coatings is shifted to the UV range.

### EXEMPLIFICATION

In order to better illustrate the present teachings, the following results from exemplary embodiments are presented hereinbelow. These teachings are not limited only to this exemplary embodiments.

### Example 1

### Coating Results for the Embodiment Shown in FIGS. 4 and 5

TABLE 2
Experimental detail for coated PMMA sheets.

| Sam- | | Surface | | Coating |
|---|---|---|---|---|
| ple | Size | Modification | Coating solution | method |
| 1 | 1 × 3″ | N | PAH (pH 6)/50 nm SiO₂ | 5 passes |
| | | | (pH 9) | |
| 2 | 1 × 3″ | N | PAH (pH 6)/50 nm SiO₂ | 5 passes |
| | | | (pH 9) | |
| 3 | 1 × 3″ | N | PAH (pH 6)/50 nm SiO₂ | 10 passes |
| | | | (pH 9) | |
| 4 | 1 × 3″ | N | PAH (pH 6)/50 nm SiO₂ | 10 passes |
| | | | (pH 9) | |
| 5 | 3 × 3″ | N | PAH (pH 3)/TM40 (pH 3) | 2D scan |
| | | | | 5 passes |
| 6 | 3 × 3″ | N | PAH (pH 3)/TM40 SiO₂ | 2D scan |
| | | | (pH 3) | 5 passes |
| 7 | 3 × 3″ | Y | PAH (pH 3)/TM40 (pH 3) | 2D scan |
| | | | | 5 passes |
| 8 | 3 × 3″ | Y | PAH (pH 3)/TM40 (pH 3) | 2D scan |
| | | | | 5 passes |
| 9 | 1 × 3″ | Y | PAH (pH 3)/TM40 (pH 3) | 10 passes |
| 10 | 1 × 3″ | Y | PAH (pH 3)/TM40 (pH 3) | 10 passes |
| 11 | 1 × 3″ | Y | PAH (pH 3)/TM40 (pH 3) | 10 passes |
| 12 | 1 × 3″ | Y | PAH (pH 3)/TM40 (pH 3) | 10 passes |
| 13 | 1 × 3″ | Y | PAH (pH 3)/TM40 (pH 3) | 10 passes |
| 14 | 3 × 3″ | Y | PAH (pH 3)/TM40 (pH 3) | 1 min/layer |
| 15 | 3 × 3″ | N | PAH (pH 6)/50 nm SiO₂ | 1 min/layer |
| | | | (pH 9) | |

Table 2 shows the tested sample sizes and applied coating solutions, coating methods. Most of PMMA samples were coated by using an impact ultrasonic nozzle system (wide and fan-shaped spray pattern). The flow rate was almost 20 ml/min and syringe dispenser system was used in case of impact nozzle. The nozzle moving speed was 7 cm/sec. For 1×3″ PMMA sheet coating, 5 times and 10 times passed of nozzle were tested and, for 3×3″ samples, nozzle path was programmed as “2D scan” and 5 time passes as shown in FIG. 4. Surface modification was performed by the methods disclosed hereinabove.

### Example 2

### Coating Results for the Embodiment Shown in FIG. 6

In order to test the efficiency the coating system shown in FIG. 6, the size of coating area, coating pathway, speed, and distance were fixed. Only different thing was coating pressure. We prepared 3×3″ PMMA samples without any surface modification, and the solution used was pH 3 PAH/pH 3 TM40 colloidal silica. The coating layer was 5 bilayers of both side coating. The coating condition of samples was summarized in Table 3. The spent time for one bilayers was under 5 min and the total operation time to finish one sample with 5 bilayers of both side coating was around 50 min. The spending time for coating can be accelerated by increasing moving speed of x, y, and z motorized stages, increasing the mist size, or reducing the coating path way.

TABLE 3
Coating conditions of samples.

| | Solution | Mist | Total spending | |
|---|---|---|---|---|
| Sample | system | pressure | time for coating | Remark |
| 1 | [PAH (pH 3)/ | N/A | 120 min | Traditional |
| | TM40 (pH 3)]₅ | | | dipping coating |
| 2 | | 20 psi | 50 min | Automated Spray |
| | | | | coating |
| 3 | | 30 psi | 50 min | Automated Spray |
| | | | | coating |

In order to compare with traditional dipping coating method, sample 1 was prepared by others and other samples were fabricated by using the automated spray coating system of FIG. 6.

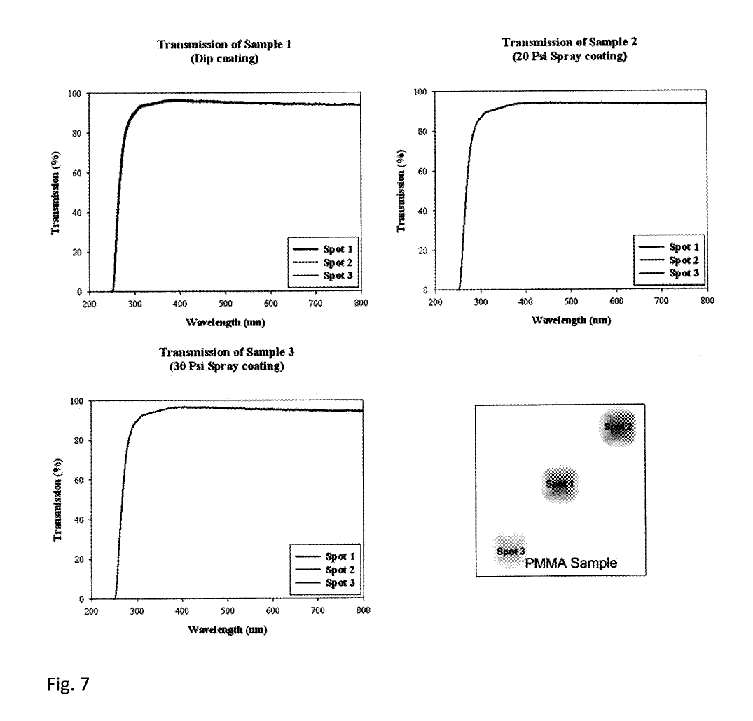

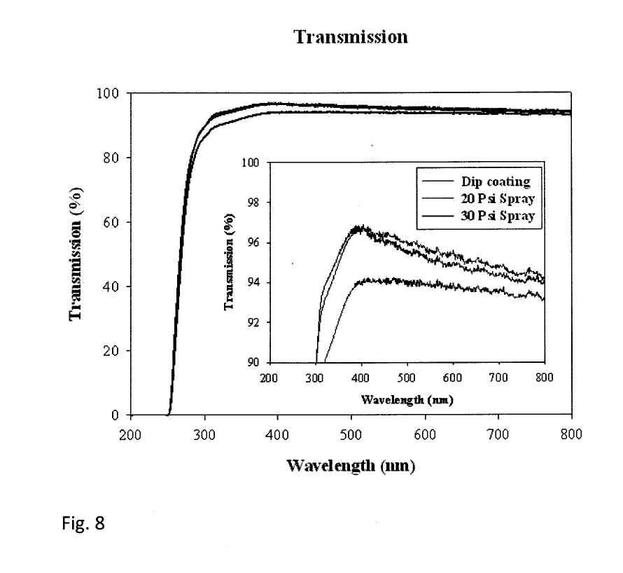

FIG. 7 and FIG. 8 show the transmission spectra of samples. Three different positions were tested in one PMMA sheet to confirm the uniformity of coating as shown in FIG. 7 (right bottom). All coating samples had a excellent uniformity. Transmission property between 30 psi spray coating by using automated spray system and traditional dipping method was almost similar as 97% at around 400 nm, but in case of 20 psi sample, little bit lower transmission was revealed (94%) as shown in FIG. 8.

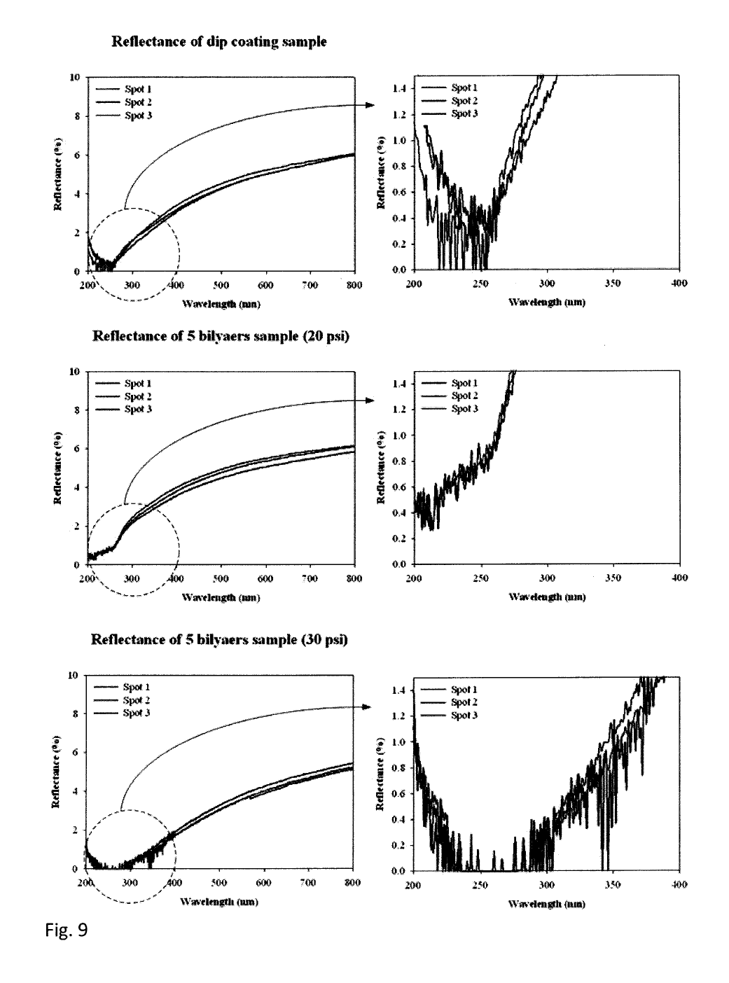

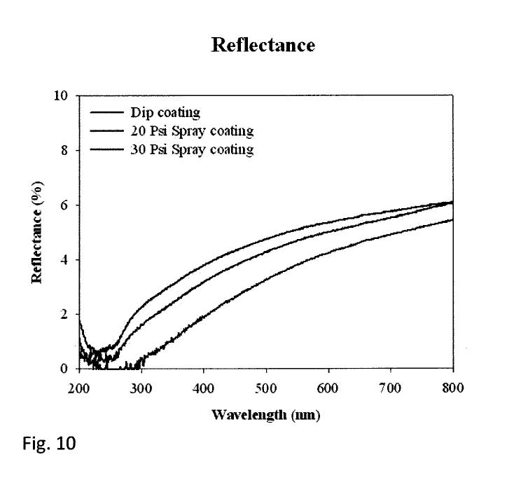

In reflectance spectra test, coating uniformity also was excellent; it was similar result with transmission as shown in FIG. 9 and FIG. 10. Reflectance of 30 psi spray sample was the better (almost 0% reflectance at 250˜300 nm) than reflectance of 20 psi spray coating sample. Reflectance of 30 psi sample was much better than traditional dip coating sample.

UV-Vis spectra were obtained for the wiping test results. The wiping test was conducted at same spot on one side of the sample. The spray coating sample seems relatively stable up to 10 wiping tests thus, wiping test up to 80 circles to check out the limitation was carried out. As a result, around 94% of original transmission was maintained and reflectance was increased almost two times under the 80 times wiping test at 350 nm.

Using the system of FIG. 6, a Fresnel lens was coated with [PAH (pH 3)/TM40 (pH 3)]₅ solution.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Although the invention has been described with respect to various embodiments, it should be realized these teachings are also capable of a wide variety of further and other embodiments within the spirit and scope of the appended claims. What is claimed is:

1. A method for preparing a thermoplastic substrate for layer by layer depositions, the substrate being prepared in order to improve adhesion of the deposited layers to the substrate, the method comprising the steps of:
dissolving a predetermined block copolymer in a predetermined solvent; the dissolving resulting in a block copolymer solution;
immersing the thermoplastic substrate in the block copolymer solution for a predetermined soaking time; the predetermined soaking time being selected such that a layer of block copolymer is formed on a surface of the thermoplastic substrate;
annealing the thermoplastic surface with the block copolymer layer at a predetermined annealing temperature for a predetermined annealing time; the predetermined annealing temperature and annealing time being selected such that block copolymer moeties are integrated into said surface and negatively charged moieties are located on said surface.

2. The method of claim 1 wherein the block copolymer layer is a monolayer of block copolymer.

3. The method of claim 1 wherein the thermoplastic substrate is Poly(methyl methacrylate) (PMMA).

4. The method of claim 2 wherein the predetermined block copolymer is poly(methylmethacrylate(-b-acrylic acid (PMMA-b-PAA).

5. The method of claim 3 wherein the predetermined solvent is 50% methanol and 50% water.

6. A method for depositing successive layers in order to produce nanoporous multilayer coatings on a substrate, the method comprising the steps of:
a) depositing on the substrate a polyelectrolyte solution and a nanoparticle solution;
b) repeating step (a) for each successive layer;
c) rinsing the deposited layers; and
d) drying the rinsed deposited layers; drying substantially removes liquid residues left on the substrate.

7. The method of claim 6 further comprising the step of:
preparing, before depositing, the substrate by the steps of:
dissolving a predetermined block copolymer in a predetermined solvent; the dissolving resulting in a block copolymer solution;
immersing the thermoplastic substrate in the block copolymer solution for a predetermined soaking time; the predetermined soaking time being selected such that a layer of block copolymer is formed on a surface of the thermoplastic substrate;
annealing the thermoplastic surface with the block copolymer layer at a predetermined annealing temperature for a predetermined annealing time; the predetermined annealing temperature and annealing time being selected such that block copolymer moeties are integrated into said surface and negatively charged moieties are located on said surface;

8. The method of claim 6 wherein the step of depositing the polyelectrolyte solution and the nanoparticle solution comprises alternate deposition of negatively charged nanoparticles and positively charged polyelectrolyte.

9. The method of claim 6 wherein the step of depositing the polyelectrolyte solution and the nanoparticle solution comprises the step of selecting a predetermined size of nanoparticles.

10. The method of claim 6 wherein the step of depositing the polyelectrolyte solution and the nanoparticle solution comprises the step of selecting pH and concentration of the nanoparticle solution.

11. The method of claim 6 wherein the step of depositing the polyelectrolyte solution and the nanoparticle solution comprises the step of selecting a polyelectrolyte.

12. The method of claim 6 wherein the step of depositing the polyelectrolyte solution and the nanoparticle solution comprises the step of selecting pH and concentration of the polyelectrolyte solution.

13. The method of claim 6 wherein nanoparticles in the nanoparticle solution comprise positively charged (+SiO₂) nanoparticles.

14. The method of claim 6 wherein nanoparticles in the nanoparticle solution comprise negatively charged (−SiO₂) nano-particles.

15. The method of claim 6 wherein polyelectrolyte in the polyelectrolyte solution comprises a positively charged poly-electrolyte.

16. The method of claim 6 wherein polyelectrolyte in the polyelectrolyte solution comprises a negatively charged poly-electrolyte.

17. A substrate for layer by layer depositions, the substrate being made by the method of claim 1.

18. A thermoplastic substrate comprising:
at least one monolayer of block copolymer formed on a surface of the thermoplastic substrate;
block copolymer moeties integrated into said surface; and
negatively charged moieties are located on said surface

19. The thermoplastic substrate of claim 18 wherein the thermoplastic substrate is poly(methyl methacrylate) (PMMA).

20. The thermoplastic substrate of claim 19 wherein the predetermined block copolymer is poly(methylmethacrylate(-b-acrylic acid (PMMA-b-PAA).

21. An apparatus for producing nanoporous multilayer coatings on a substrate, the apparatus comprising:
at least one atomizing mist delivery component receiving a liquid and a gas; said liquid comprising a polyelectrolyte solution and/or a nanoparticle solution when used in a coating operation; said liquid comprising a rinsing solution when used in a cleaning operation; said atomizing mist delivery component delivering a coating mist when used in a coating operation, a rinsing solution when used in a cleaning operation and a pressurized gas when used in a drying operation; and
a thermoplastic substrate disposed to receive fluid from said at least one atomizing mist delivery component; said at least one atomizing mist delivery component and said thermoplastic substrate being displaceable with respect to each other.

22. The apparatus of claim 21 wherein the thermoplastic substrate comprises:
at least one monolayer of block copolymer formed on a surface of the thermoplastic substrate;
block copolymer moeties integrated into said surface; and
negatively charged moieties are located on said surface.

23. The apparatus of claim 22 wherein the thermoplastic substrate is Poly(methyl methacrylate) (PMMA).

24. The apparatus of claim of claim 23 wherein the predetermined block copolymer is poly(methylmethacrylate(-b-acrylic acid (PMMA-b-PAA).

25. The apparatus of claim 21 wherein said at least one atomizing mist delivery component is at least one of an air assisted atomizing nozzle, an ultrasonic-assisted atomizing nozzle or a piezoelectric-assisted atomizing nozzle.

26. The apparatus of claim 21 wherein the thermoplastic substrate is Poly(methyl methacrylate) (PMMA).

27. The apparatus of claim 21 wherein nanoparticles in the nanoparticle solution comprise positively charged (+SiO₂) nanoparticles.

28. The apparatus of claim 21 wherein nanoparticles in the nanoparticle solution comprise negatively charged (−SiO₂) nano-particles.

29. The apparatus of claim 21 wherein polyelectrolyte in the polyelectrolyte solution comprises a positively charged poly-electrolyte.

30. The apparatus of claim 21 wherein polyelectrolyte in the polyelectrolyte solution comprises a negatively charged poly-electrolyte.

31. An anti-reflective coating produced by the method of claim 6.

32. The antireflective coating of claim 31 wherein the antireflective coating provides antireflective properties in a UV electromagnetic spectrum range.

33. The antireflective coating of claim 32 wherein each layer has a thickness between about 60 nm to about 70 nm.
